(19) United States
(12) Patent Application Publication
(10) Pub. No.: US 2020/0058193 A1
(43) Pub. Date: Feb. 20, 2020

(54) SYSTEMS FOR STANDARDIZED SCORING WAGERING

(71) Applicants: Miles Arnone, Cambridge, MA (US); Eric Meyerhofer, Pasadena, CA (US); Caitlyn Ross, Watertown, MA (US)

(72) Inventors: Miles Arnone, Cambridge, MA (US); Eric Meyerhofer, Pasadena, CA (US); Caitlyn Ross, Watertown, MA (US)

(21) Appl. No.: 16/548,762

(22) Filed: Aug. 22, 2019

Related U.S. Application Data
(63) Continuation of application No. 15/954,136, filed on Apr. 16, 2018, now abandoned.
Application No. 15/954,136 is a continuation of application No. 14/708,141, filed on May 8, 2015, now Pat. No. 9,947,179.
Application No. 14/708,141 is a continuation of application No. PCT/US13/67140, filed on Oct. 28, 2013.
(60) Provisional application No. 61/723,878, filed on Nov. 8, 2012.

(51) Int. Cl. G07F 17/32

(52) U.S. Cl. CPC G07F 17/3258; G07F 17/3225; G07F 17/3272

(57) ABSTRACT

A method of operating a gaming system including: receiving by the gaming system from a player an input of real world credit; providing by the gaming system a display screen that depicts a representation of an entertainment game in which score values directly correlate to a standardized score; determining by the gaming system a game world score for a period of time; determining by the gaming system a standardized score value using the game world score; displaying by the gaming system the standardized score value; determining by the gaming system a gambling outcome, wherein the determination of the gambling outcome is triggered by trigger in the entertainment game; and allocating by the gaming system the randomly generated payout of real world credits to the credit meter.

### CROSS-REFERENCE TO RELATED APPLICATIONS

This application is a continuation of U.S. patent application Ser. No. 15/954,136, filed Apr. 16, 2018, which is a continuation of U.S. patent application Ser. No. 14/708,141, filed May 8, 2015, which is a continuation of Patent Cooperation Treaty Application No. PCT/US13/67140, filed Oct. 28, 2013 which claims the benefit of U.S. Provisional Application No. 61/723,878, filed Nov. 8, 2012, the disclosure of which is incorporated herein by reference as if set forth herewith.

### FIELD OF THE INVENTION

Embodiments of the present invention are generally related to gaming and more specifically to systems and processes that provide a standardized scoring system for gambling hybrid games.

### BACKGROUND OF THE INVENTION

The gaming machine manufacturing industry provides a variety of gaming machines to enable wagering for interested parties whilst providing an entertainment experience. An exemplary gaming machine is a slot machine. As the demographic of eligible players has shifted with time to newer generations who have grown accustomed to highly sophisticated graphics and interactive video games, a need has arisen to increase the entertainment content present on a gaming machine to keep it relevant, at least to a growing portion of a casino's patronage. The subject design is a form of gaming machine, designed for use in a physical or virtual casino environment, which provides players an environment in which to play for cash, prizes and points, either against the casino or in head to head modes in a controlled and regulated manner while being allowed to use their skills and adeptness at a particular type of game. An example of such a game would be a challenging word spelling game, or an interactive action game such as is found on video game consoles popular today, such as a PlayStation®, an Xbox®, a Wii® or a PC based.

### SUMMARY

A regulated gambling proposition may be executed by a server in a regulated environment. In addition, a mobile computing device executing an entertainment game may operate in an environment separate from the regulated environment. A controller maintains the separation between the server and the mobile computing device and provides an interface between the server and the mobile computing device.

An embodiment of the invention includes a mobile computing device connected to a controller by a network, wherein the mobile computing device is constructed to execute an entertainment game; a server connected to the controller via a communication link, the server constructed to determine a result of a wagering event and provide the results of the wagering event to the controller; the controller connected to the mobile computing device by the network and connected to the server by the communication link, wherein the controller is constructed to: determine when a wagering event occurs during play of the entertainment game; request, from the server via the communication link, a resolution to the wagering event; receive, from the mobile computing device by the network, a score value; receive, from the mobile computing device by the network, an amount of real credit committed; map the score value to a standardized score value using the score value and the real credit commitment; and update an account of the player with the standardized score value.

In a further embodiment, the controller is further constructed to provide the standardized score value to the player through the mobile computing device.

In a further embodiment, the controller performs the mapping of the score value to the standardized score by applying a linear mapping of the score value to a standardized score in a particular range.

In a further embodiment, the controller performs the mapping of the score value to the standardized score by applying a nonlinear mapping of the score value to a standardized score in a particular range.

In a further embodiment, the controller is constructed to map the score value to the standardized score by applying a weighting application to the score value to determine a standardized score within a range of standardized scores wherein the weighting application is based upon a distribution of players against the score values.

In a further embodiment, the controller is constructed to map the score value to the standardized score by applying a formulaic conversion to the score value to determine the standardized score wherein the formulaic conversion takes into account at least one entertainment game metric.

In a further embodiment, the mobile computing device is constructed to have score values that directly correlate to the standardized scores and the controller is constructed to map the score value to the standardized score by a one to one correlation.

In an embodiment, an electronic gaming machine for standardized scoring wagering includes an entertainment software engine hosted by the electronic gaming machine, wherein the entertainment software engine is connected to a game world engine, and wherein the entertainment software engine is constructed to: execute an entertainment game having score values for gameplay; determine a native score value for the player during the player's play of the entertainment game; provide to the game world engine the native score value; receive, from the game world engine a standardized score value; and display the standardized score value to the player. The electronic gaming machine for standardized scoring wagering further includes a real world engine hosted by the electronic gaming machine and connected to the game world engine, wherein the real world engine is constructed to: determine a result of a wagering event using a random number generator; and provide the results of the wagering event to the game world engine. The game world engine hosted by the electronic gaming machine and connected to the entertainment software engine and connected to the game world engine is constructed to: determine when a wagering event occurs during the player's play of the entertainment game; request, from the real world engine, a resolution to the wagering event; receive, from the entertainment software engine the native score value; determine an amount of real credit commitment for the wagering event; map the native score value to the standardized score value using a one to one correlation and the real credit commitment; distribute the standardized score value to the player through the entertainment software engine; and update an account of the player with the standardized score value.

In another embodiment, the game world engine is further constructed to adjust the mapping of the native score value to the standardized score by also applying a linear mapping of the native score value to the standardized score in a particular range.

In yet another embodiment, the game world engine is further constructed to adjust the mapping of the native score value to the standardized score by also applying a nonlinear mapping of the native score value to the standardized score in a particular range.

In yet another embodiment, the game world engine is further constructed to map the score value to the standardized score by further applying a weighting application to the native score value to determine the standardized score within a range of standardized scores wherein the weighting application is based upon a distribution of players against score values.

In yet another embodiment, the game world engine is further constructed to map the native score value to the standardized score by further applying a formulaic conversion to the native score value to determine the standardized score wherein the formulaic conversion takes into account at least one entertainment game metric.

In an embodiment, an electronic gaming machine for standardized scoring wagering includes at least one processor and a memory connected to the at least one processor where the memory contains executable instructions that when executed by the processor cause the at least one processor to: execute an entertainment game having score values for gameplay; determine a native score value for the player during the player's play of the entertainment game; determine when a wagering event occurs during the player's play of the entertainment game; determine a result of the wagering event using a random number generator; determine an amount of real credit commitment for the wager event; map the native score value for the player to a standardized score value using a one to one correlation and the real credit commitment; display the standardized score value to the player; and update an account of the player with the standardized score value.

In another embodiment, the executable instructions when executed by the at least one processor further cause the at least one processor to adjust the mapping of the native score value to the standardized score by also applying a linear mapping of the native score value to the standardized score in a particular range.

In yet another embodiment, the executable instructions when executed by the at least one processor further cause the at least one processor to adjust the mapping of the native score value to the standardized score by also applying a nonlinear mapping of the native score value to the standardized score in a particular range.

In yet another embodiment, the executable instructions when executed by the at least one processor further cause the at least one processor to map the native score value to the standardized score by further applying a weighting application to the native score value to determine the standardized score within a range of standardized scores wherein the weighting application is based upon a distribution of players against score values.

In yet another embodiment, the game world engine is further constructed to map the native score value to the standardized score by further applying a formulaic conversion to the native score value to determine the standardized score wherein the formulaic conversion takes into account at least one entertainment game metric.

### BRIEF DESCRIPTION OF THE DRAWINGS

FIG. 1 illustrates a conceptual diagram of components of a gambling hybrid game in accordance with an embodiment of the invention.

FIG. 2 illustrates a conceptual diagram of aspects of a real world engine (RWE) of a gambling hybrid game in accordance with some embodiments of the invention.

FIG. 3 illustrates a conceptual diagram of aspects of a real world engine of a gambling hybrid game in accordance with some other embodiments of the invention.

FIG. 4 illustrates a signaling diagram of communications between a real world engine (RWE) and an external system to provide various functions in accordance with embodiments of the invention.

FIG. 5 illustrates a conceptual diagram of a process flow and signaling in an RWE to provide various functions in accordance with embodiments of the invention.

FIG. 6 illustrates a conceptual diagram of aspects of an entertainment system engine in accordance with embodiments of the invention.

FIG. 7 illustrates a conceptual diagram of interactions between a user and a gambling hybrid game in accordance with embodiments of the invention.

FIG. 8 illustrates conceptual diagram that illustrates the interplay between aspects of a gambling hybrid game in accordance with some embodiments of the invention using real world credit (RWC).

FIG. 9 illustrates conceptual diagram that illustrates the interplay between aspects of a gambling hybrid game in accordance with other embodiments of the invention using Virtual real world credit (VRWC).

FIG. 10 illustrates a system diagram of an implementation of a network based gambling hybrid game in accordance with another embodiment of the invention.

FIG. 11 illustrates a system diagram of an implementation of an Internet based gambling hybrid game in accordance with an embodiment of the invention.

FIG. 12 illustrates a system diagram of an implementation of a cloud based gambling hybrid game in accordance with embodiments of the invention.

FIG. 13 illustrates a block diagram of components of a device implementing a gambling hybrid game in accordance with an embodiment of the invention.

FIG. 14 illustrates a distribution of gambling hybrid scores of players to a range of standardized scores.

FIG. 15 illustrates a flow diagram of a process for determining a mapping function for converting a gambling hybrid score to a standardized score in accordance with embodiments of the invention.

FIG. 16 illustrates a flow diagram for a process that converts a gambling hybrid score to a standardized score in accordance with embodiments of the invention.

### DETAILED DISCLOSURE OF THE INVENTION

Turning now to the drawings, systems and method for a standardized scoring system for gambling hybrid games in accordance with some embodiments of the invention are illustrated. In gambling hybrid games, game world credit (GWC) scoring (the addition or subtraction of GWC to a player's account) can be independently determined by an individual gambling hybrid game, and/or by a standardized system of scoring applied to more than one gambling hybrid game. A standardized scoring system in accordance with many embodiments of the invention enables a unified mechanism for managing tournament entry, for a player to evaluate his or her performance across multiple game titles, and because it can simplify and/or eliminate the need for an exchange dedicated to trading GWC (the GWCE).

### Gambling Hybrid Games

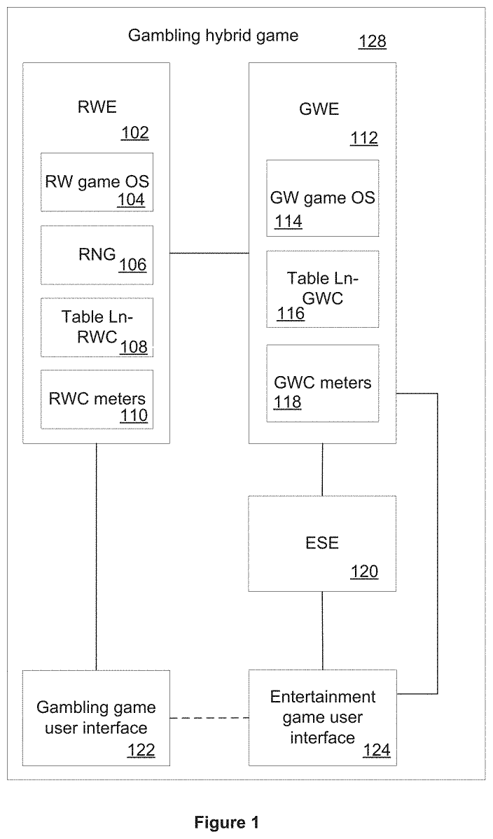

In accordance with many embodiments of the invention, a gambling hybrid game integrates high-levels of entertainment content with a game of skill (entertainment game) and a gambling experience with a game of chance (gambling game). A gambling hybrid game provides for random outcomes independent of player skill while providing that the user's gaming experience (as measured by obstacles/challenges encountered, time of play and other factors) is shaped by the player's skill. The outcome of a gambling proposition that is determined by a Random Number Generator (RNG) or other such device that provides a random or pseudorandom outcome in response to a request. In accordance with some embodiments, the wager game may be initiated in response to a game object related player action. A gambling hybrid game in accordance with an embodiment of the invention is illustrated in FIG. 1. The gambling hybrid game 128 includes a real world engine (RWE) 102, a game world engine (GWE) 112, an entertainment system engine (ESE) 120, a gambling game user interface 122 and an entertainment game user interface 124. The two user interfaces can be part of the same user interface but are separate in the illustrated embodiment. The RWE 102 is connected with the GWE 112 and the gambling game user interface 122. The ESE 120 is connected with the GWE 112 and the entertainment game user interface 124. The GWE 112 is connected also with the entertainment game user interface 124.

In accordance with several embodiments, the RWE 102 is the operating system for the gambling game of the gambling hybrid game 128 and controls and operates the gambling game. The operation of a gambling game is enabled by real world credit (RWC), such as money or other real world funds. A gambling game can increase or decrease an amount of RWC based on random gambling outcomes, where the gambling proposition of a gambling game is typically regulated by gaming control bodies. In many embodiments, the RWE includes a Real World (RW) operating system (OS) 104, RNG 106, level n real-world credit pay tables (table Ln-RWC) 108, RWC meters 110 and other software constructs that enable a game of chance to offer a fair and transparent gambling proposition, and to contain the auditable systems and functions that can enable the game to obtain gaming regulatory body approval.

A random number generator (RNG) 106 includes software and/or hardware algorithms and/or processes, which are used to generate random outcomes. A level n real-world credit pay table (table Ln-RWC) 108 is a table that can be used in conjunction with a random number generator (RNG) 106 to dictate the RWC earned as a function of sponsored gameplay and is analogous to the pay tables used in a conventional slot machine. Table Ln-RWC payouts are independent of player skill. There can be one table or multiple tables included in Ln-RWC pay tables 108 contained in a gambling game, the selection of which can be determined by factors including (but not limited to) game progress that a player has earned, and/or bonus rounds for which a player can be eligible. RWCs are credits analogous to slot machine game credits, which are entered into a gambling game by the user, either in the form of money such as hard currency or electronic funds. RWCs can be decremented or augmented based on the outcome of a random number generator according to the table Ln-RWC real world credits pay table 108, independent of player skill. In certain embodiments, an amount of RWC can be used as criteria in order to enter higher ESE game levels. RWC can be carried forward to higher game levels or paid out if a cash out is opted for by a player. The amount of RWC used to enter a specific level of the game level n need not be the same for each level.

In accordance with some embodiments of the invention, the GWE 112 manages the overall gambling hybrid game operation, with the RWE 102 and the ESE 120 effectively being support units to the GWE 112. In accordance with some of these embodiments, the GWE 112 contains mechanical, electronic, and software systems for an entertainment game. The GWE 112 includes an operating system (OS) 114 that provides control of the entertainment game. The GWE additionally contains a level n game world credit pay table (table Ln-GWC) 116 from where to take input from this table to affect the play of the entertainment game. The GWE 112 can further couple to the RWE 102 to determine the amount of RWC available on the game and other metrics of wagering on the gambling game (and potentially affect the amount of RWC in play on the RWE). The GWE additionally contains various audit logs and activity meters (such as the GWC meter) 118. The GWE 112 can also couple to a centralized server for exchanging various data related to the player and their activities on the game. The GWE 112 furthermore couples to the ESE 120.

In accordance with some embodiments, a level n game world credit pay table (Table Ln-GWC) 116 dictates the game world credit (GWC) earned as a function of player skill in the nth level of the game. The payouts governed by this table are dependent upon player skill and sponsored gameplay at large and can or cannot be coupled to a RNG. In accordance with some embodiments, GWCs are player points earned or depleted as a function of player skill, specifically as a function of player performance in the context of the game. GWC is analogous to the score in a typical video game. Each entertainment game has one or more scoring criterion, embedded within the table Ln-GWC 116 that reflects player performance against the goal(s) of the game. GWCs can be carried forward from one level of sponsored gameplay to another, and ultimately paid out in various manners such as directly in cash, or indirectly such as by earning entrance into a sweepstakes drawing, or earning participation in, or victory in, a tournament with prizes. GWCs can be stored on a player tracking card or in a network-based player tracking system, where the GWCs are attributed to a specific player.

In accordance with certain embodiments, the operation of the GWE does not affect the RWE's gambling operation except for player choice parameters that are allowable in slot machines, including but not limited to, wager terms such as, but not limited to, a wager amount, how fast the player wants to play (by pressing a button or pulling the handle of a slot machine), and/or agreement to wager into a bonus round. In this sense, the RWE 102 provides a fair and transparent, non-skill based gambling proposition co-processor to the GWE 112. In the illustrated embodiment, the communication link shown between the GWE 112 and the RWE 102 allows the GWE 112 to obtain information from the RWE 102 as to the amount of RWC available in the gambling game. The communication link can also convey a status operation of the RWE (such as on-line or tilt). The communication link can further communicate the various gambling control factors which the RWE 102 uses as input, such as the number of RWC consumed per game or the player's election to enter a jackpot round. In FIG. 1, the GWE 112 is also shown as connecting to the player's user interface directly, as this can be utilized to communicate certain entertainment game club points, player status, control the selection of choices and messages which a player can find useful in order to adjust the entertainment game experience or understand their gambling status in the RWE 102.

In accordance with various embodiments of the invention, the ESE 120 manages and controls the visual, audio, and player control for the entertainment game. In accordance with certain embodiments, the ESE 120 accepts input from a player through a set of hand controls, and/or head, gesture, and/or eye tracking systems and outputs video, audio and/or other sensory output to a user interface. In accordance with many embodiments, the ESE 120 can exchange data with and accept control information from the GWE 112. In accordance with some of these embodiments, an ESE 120 can be implemented using a personal computer (PC), a Sony PlayStation® (a video game console developed by Sony Computer Entertainment of Tokyo Japan), or Microsoft Xbox® (a video game console developed by Microsoft Corporation of Redmond, Wash.) running a specific entertainment game software program. In accordance with some of these embodiments, ESE 120 can be an electromechanical game system of a draw certificate based gambling hybrid game that is an electromechanical gambling hybrid game. An electromechanical gambling hybrid game executes an electromechanical game for player entertainment. The electromechanical game can be any game that utilizes both mechanical and electrical components, where the game operates as a combination of mechanical motions performed by at least one player or the electromechanical game itself. Various electromechanical gambling hybrid games are discussed in Patent Cooperation Treaty Application No. PCT/US12/58156, filed Sep. 29, 2012, the contents of which are hereby incorporated by reference in their entirety.

The ESE 120 operates mostly independently from the GWE 112, except that via the interface, the GWE 112 can send certain entertainment game control parameters and elements to the ESE 120 to affect its play, such as (but not limited to) what level of character to be using, changing the difficulty level of the game, changing the type of gun or car in use, and/or requesting potions to become available or to be found by the character. These game control parameters and elements can be based on a gambling outcome of a gambling game that was triggered by an element in the entertainment game being acted upon by the player. The ESE 120 can accept this input from the GWE 112, make adjustments, and continue entertainment game gameplay all the while running seamlessly from the player's perspective. The ESE's operation is mostly skill based, except for where the ESE's processes can inject complexities into the game by chance in its normal operation to create unpredictability in the entertainment game. Utilizing this interface, the ESE 120 can also communicate player choices made in the game to the GWE 112, such as but not limited to selection of a different gun, and/or the player picking up a special potion in the GW environment. The GWE's function in this architecture, being interfaced with the ESE 120, is to allow the transparent coupling of entertainment software to a fair and transparent random chance gambling game, providing a seamless perspective to the player that they are playing a typical popular entertainment game (which is skill based). In accordance with certain embodiments, the ESE 120 can be used to enable a wide range of entertainment games including but not limited to popular titles from arcade and home video games, such as but not limited to Gears of War (a third person shooter game developed by Epic Games of Cary, N.C.), Time Crisis (a shooter arcade game developed by Namco Ltd of Tokyo, Japan), or Madden Football (an American football video game developed by EA Tiburon of Maitland, Fla.). Providers of such software can provide the previously described interface by which the GWE 120 can request amendments to the operation of the ESE software in order to provide seamless and sensible operation as both a gambling game and an entertainment game.

In accordance with some embodiments, the RWE 102 can accept a trigger to run a gambling game in response to actions taken by the player in the entertainment game as conveyed by the ESE 120 to the GWE 112, or as triggered by the GWE 112 based on its algorithms, background to the overall game from the player's perspective, but can provide information to the GWE 112 to expose the player to certain aspects of the gambling game, such as (but not limited to) odds, amount of RWC in play, and amount of RWC available. The RWE 102 can accept modifications in the amount of RWC wagered on each individual gambling try, or the number of gambling games per minute the RWE 102 can execute, entrance into a bonus round, and other factors, all the while these factors can take a different form than that of a typical slot machine. An example of a varying wager amount that the player can choose can include, but is not limited to, gameplay with a more powerful character, a more powerful gun, or a better car. These choices can increase or decrease the amount wagered per individual gambling game, in the same manner that a standard slot machine player can decide to wager more or less credits for each pull of the handle. In accordance with some of these embodiments, the RWE 102 can communicate a number of factors back and forth to the GWE 112, via an interface, such increase/decrease in wager being a function of the player's decision making as to their operational profile in the entertainment game (such as but not limited to the power of the character, gun selection or car choice). In this manner, the player is always in control of the per game wager amount, with the choice mapping to some parameter or component that is applicable to the entertainment game experience of the gambling hybrid game. In accordance with a particular embodiment, the RWE 102 operation can be a game of chance as a gambling game running every 10 seconds where the amount wagered is communicated from the GWE 112 as a function of choices the player makes in the operation profile in the entertainment game.

In many embodiments, a gambling hybrid game integrates a video game style gambling machine, where the gambling game (including an RWE 102 and RWC) is not player skill based, while at the same time allows players to use their skills to earn club points which a casino operator can translate to rewards, tournament opportunities and prizes for the players. The actual exchange of monetary funds earned or lost directly from gambling against a game of chance in a gambling game, such as a slot machine, is preserved. At the same time, a rich environment of rewards to stimulate gamers can be established with the entertainment game. In accordance with some of these embodiments, the gambling hybrid game can leverage very popular titles with gamers and provides a sea change environment for casinos to attract players with games that are more akin to the type of entertainment that a younger generation desires. In accordance with various embodiments, players can use their skill towards building and banking GWC that in turn can be used to win tournaments and various prizes as a function of their gamer prowess. Numerous embodiments minimize the underlying changes needed to the aforementioned entertainment software for the gambling hybrid game to operate within an entertainment game construct, thus making a plethora of complex game titles and environments, rapid and inexpensive to deploy in a gambling environment.

In accordance with some embodiments, gambling hybrid games also allow players to gain entry into subsequent competitions through the accumulation of game world credits (GWC) as a function of the user's demonstrated skill at the game. These competitions can pit individual players or groups of players against one another and/or against the casino to win prizes based upon a combination of chance and skill. These competitions can be either asynchronous events, whereby players participate at a time and/or place of their choosing, or they can be synchronized events, whereby players participate at a specific time and/or venue.

In accordance with some embodiments, one or more players engage in playing an entertainment game, resident in the ESE, the outcomes of which are dependent at least in part on skill. The gambling hybrid game can include an entertainment game that includes head to head play between a single player and the computer, between two or more players against one another, or multiple players playing against the computer and/or each other, as well as the process by which players bet on the outcome of the entertainment game. The entertainment game can also be a game where the player is not playing against the computer or any other player, such as in games where the player is effectively playing against himself or herself (such as but not limited to Solitaire and Babette).

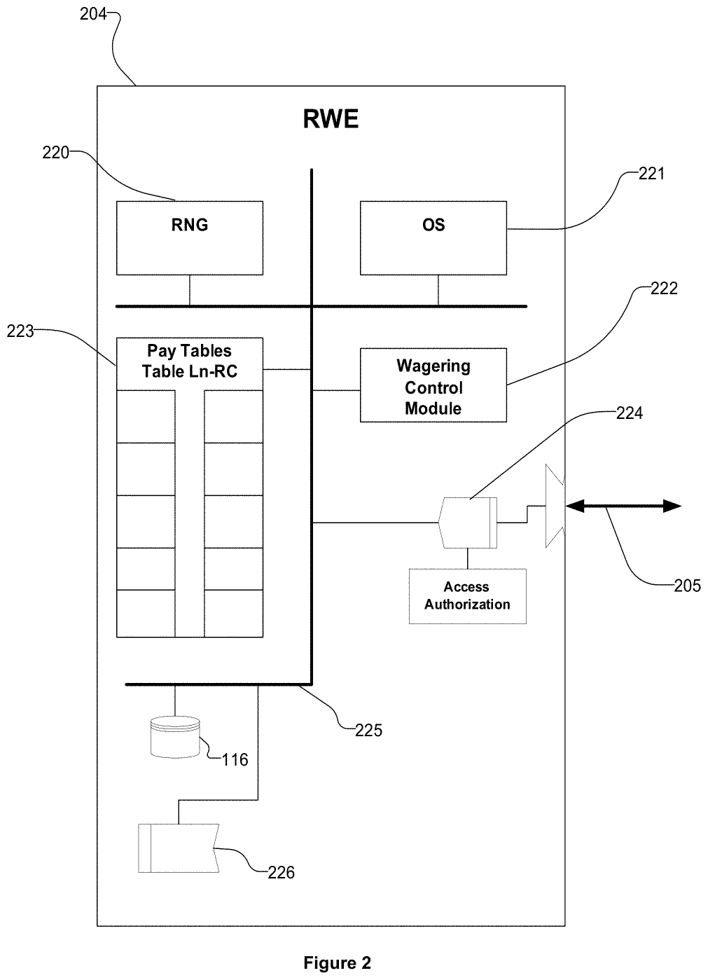

The components provided by the RWE for a gambling hybrid game in accordance with embodiments of the invention are shown in FIG. 2. In accordance with embodiments of the invention, the RWE includes an internal bus 225 that connects an operating system OS 221, a Random Number Generator (“RNG”) 220, one or more pay tables (Table Ln-RC) 223 which would control the functions of the RWE, a Random Number Generator (“RNG”) 220 to produce random numbers, one or more pay tables (Table Ln-RC) 223, a wagering control module 222, an authorization access module 224, and a RC credit meter 226 that are included in the RWE 204. The RW OS 221 controls the functions of the RWE. The RNG 220 includes one or more RNGs that are used to produce random numbers for use in resolving gambling events and other process requiring a random number to determine an outcome. The one or more pay tables (Table Ln-RC) 223 contain a plurality of factors indexed by the random number to be multiplied with the RC wagered to determine the payout on a successful wager. A wagering control module 222 performs the processes to resolve a wager on a proposition of a gambling event. The resolution process includes, but is not limited to, pulling random numbers, looking up factors in Pay Tables, multiplying the factors by the amount of RC wagered, and administering a RC credit meter 226. A repository (a credit meter) 926 maintains a record of the amount of RC which player has deposited in the game and has been accumulated by the player.

An external connection allows the RWE 204 to interface to another system or device, which is shown in FIG. 2 as the internet 205 but may be any other network and/or device. The authorization access module 224 of RWE 204 is connected to the external connection and provides a method to permit access and command exchange between an external system and the RWE 904. The RWE 904 also contains storage for statuses, wagers, wager outcomes, meters and other historical events in a storage device 116.

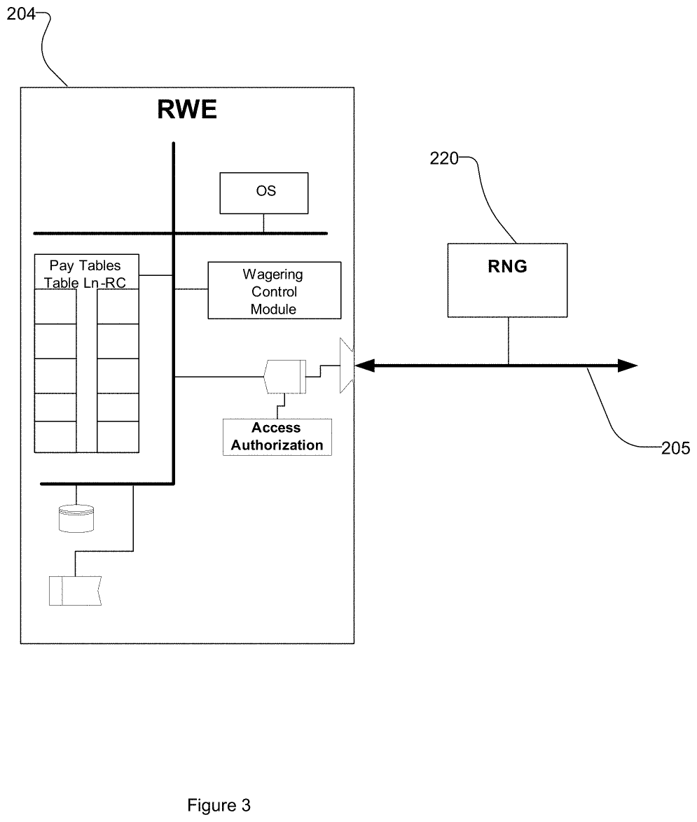

In some embodiments, the RWE communicates with external systems to provide various functions of a gambling hybrid game in accordance with embodiments of the invention. The components of an RWE that communicate with an external system to provide a component of the RWE in accordance with embodiments of the invention are shown in FIG. 3. The RWE 204 shown in FIG. 3 is similar to the RWE shown in FIG. 2. However, the RNG 220 which is an external system connected to the RWE 204 by the internet 905 in accordance with embodiments of the invention. The RNG 220 could be a central deterministic system, such as a regulated and controlled random numbered ball selection device, or some other system which provides random or pseudo random numbers to one or a plurality of connected RWEs 204. One skilled in the art will recognize that only RNG 220 is an external system in the shown embodiments. However, any of the components could be external systems without departing from the invention and RNG 220 is shown as an example only.

In FIGS. 2 and 3, the RWE 204 interfaces with other systems/devices or to an external RNG 220 using the Internet 205. However, one skilled in the art will note that nothing would preclude using a different interface than the internet 205 in other embodiments of the invention. Other examples of interfaces include, but are not limited to, a LAN, a USB interface, or some other method by which two electronic and software constructs could communicate with each other.

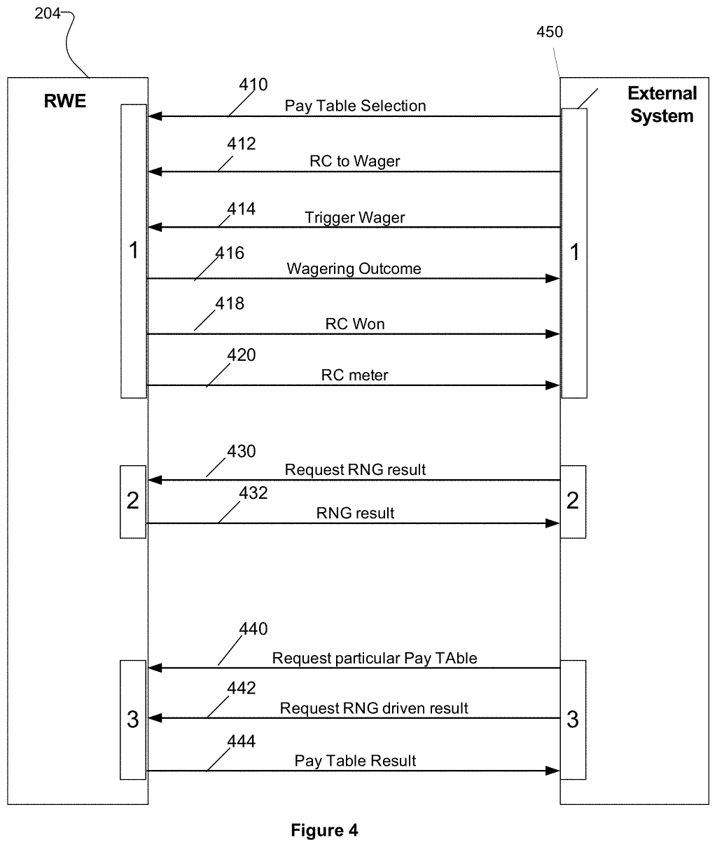

The RWE and an external system typically communicate to provide the resolution of gambling events to resolve wagers on the events. The signals between the RWE and an external system to provide some process related to resolving gambling events in accordance with embodiments of the invention are shown in FIG. 4. In accordance with embodiments of the invention, the primary function of the RWE 204 is to manage wagering events and to provide random (or pseudo random) numbers from an RNG. At the top of the figure, a 6 component communication exchange grouped by the “1” box is shown for a wager on a proposition in a gambling event during a gambling hybrid game in accordance with embodiments of the invention. An external system 450 that is requesting wagering support from the RWE 204 instructs the RWE 204 as to the pay table (Table Ln-RC) to use (410), followed by the amount of RC to wager on the proposition of the gambling event (412). Next, the external system 450 signals the RWE to trigger a wager or perform the gambling event (414). The RWE 204 resolves the gambling event. The RWE 204 then informs external system 450 as to the outcome of the wager (416), the amount of RC won (418), and the amount of RC in the player's account (in the credit repository) (420).

A second communication exchange between the RWE 204 and an external system 450 in accordance with embodiments of the invention that is shown in FIG. 4 is grouped by the “2” box in FIG. 4 and relates to the external system 450 needing an RNG result support from the RWE 204. In this exchange, the external system 450 requests an RNG result from the RWE 204 (430). The RWE 204 returns an RNG result to the external 450 in response to the request (432). The result may be generated as a function of the internal RNG in the RWE 204, or from an RNG external to the RWE 204 to which the RWE 204 is connected.

A third communication exchange between the RWE 204 and the external system 405 in accordance with embodiments of the invention that is shown in FIG. 4 is grouped by the “3” box in the figure and relates to the external system 450 wanting support on coupling an RNG result to a particular Pay Table contained in the RWE 204. In this exchange, the external system 450 instructs the RWE as to the pay table (Table Ln-RC) to use 450. The external system then requests a result whereby the RNG result is coupled to the requested Pay Table (442). The result is returned to the external system 405 by RWE 204 (444). Such an aspect is different from the first exchange shown by the box “1” sequence in that no actual RC wager is conducted. However, such a process t might be useful in coupling certain non-RC wagering entertainment game behaviors and propositions to the same final resultant wagering return which is understood for the gambling hybrid game to conduct wagering.

In regards to FIG. 4, one skilled in the art will note that the thrust of the FIG. 4 is to convey overall functional exchanges between an RWE 204 and an external system 450. As such, various protocol layers necessary for error free and secure communication, and other status, setup, and configuration commands which one might expect in any protocol between two connected systems have been omitted for clarity. Furthermore, some or all of the various commands and responses illustrated could be combined into one or more communication packets without departing from the invention.

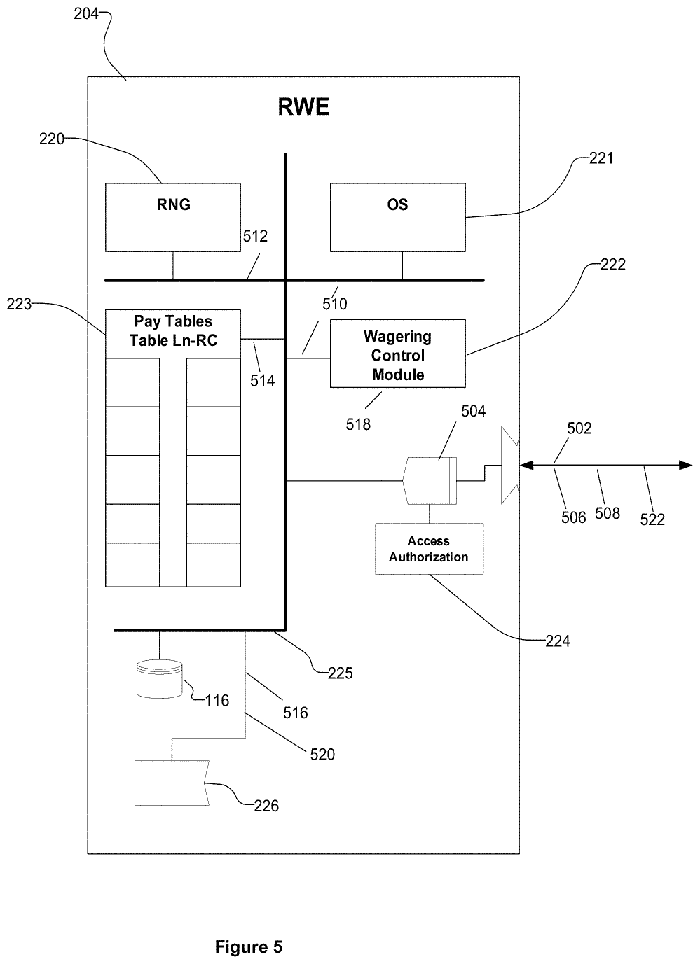

The process flow for functional communication exchanges, such as communication exchanges described above with reference to FIG. 4, between a RWE and an external system in accordance with embodiments of the invention are shown in FIG. 5. The process begins by a RWE 204 receiving signals from an external system requesting a connection to RWE 204. The Access Authorization Module determines that the external system authorized to connect to RWE 204 (504) and transmits an authorization response to the external system. The external systems that provide requests a request for a gambling event is to be performed to RWE 294 (506). The request may include an indication of a wager amount on a proposition in the gambling event, and a proper pay table to use to resolve the wager. The external system then sends a signal to trigger the gambling event (508).

The OS 221 instructs the Wager Control Module 222 as to the RC wager and the Pay Table to select as well as to resolve the wager execute (510). In response to the request to execute the gambling event, the wager control module 222 requests an RNG result from the RNG 220 (512); retrieves a proper pay table or tables from the pay tables 223 (514); adjusts the RC of the player in the RC repository 926 as instructed (516; applies the RNG result to the particular pay table or tables (518); and multiplies the resultant factor from the Pay Table by the amount of RC to determine the result of the wager (518). Wager Control Module 222 then adds the amount of RC won by the wager to the RC repository 426 (520); and provides he outcome of the wager, and the amount of RC in the RWE and the RC won (522). One skilled in the art will recognize that there may be many embodiments of an RWE 204 which could be possible, including forms where many modules and components of the RWE are located in various servers and locations, so the foregoing is not meant to be exhaustive or all inclusive, but rather provide information about an RWE 204 in accordance with some embodiments of the invention.

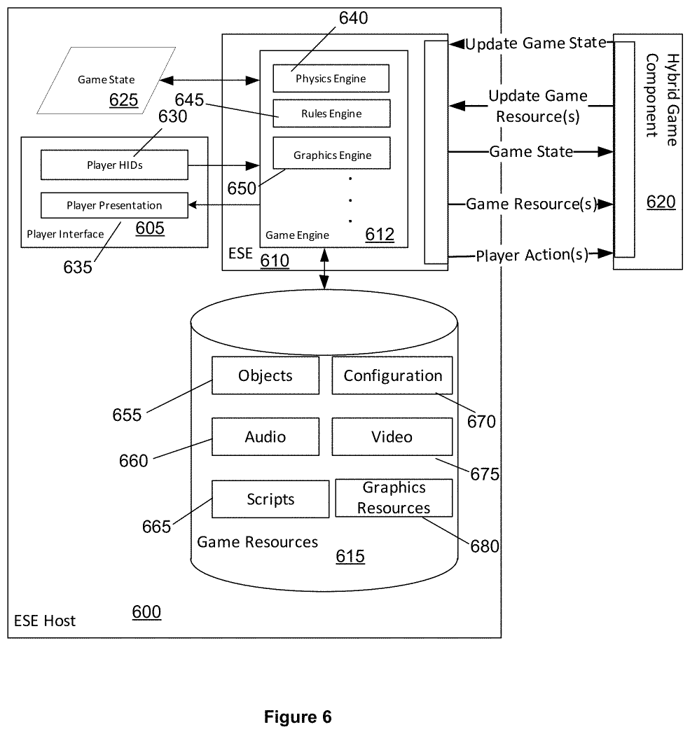

A block diagram of components an ESE being provided by an ESE host for a gambling hybrid game in accordance with embodiments of the invention are shown in FIG. 6. An ESE 610 may be part of the entertainment game itself, may be a software module that is executed by the entertainment game, or may provide an execution environment for the entertainment game for a particular host. The ESE 610 and associated entertainment game are hosted by an ESE host 600. The ESE host 600 is a computing device that is capable of hosting the ESE 610 and the entertainment game. Exemplary hosts include video game consoles, smart phones, personal computers, tablet computers, or the like. The entertainment game includes a game engine 612 that generates a player interface 605 for interaction with by a player. The player interface includes a player presentation 635 that is presented to a player through the player interface. The player presentation 635 may be audio, visual or tactile, or any combination of such. The player interface 635 further includes one or more Human Input Devices (HIDs) 630 that the player uses to interact with the entertainment game. Various components or sub-engines of the game engine read data from a game state in order to implement the features of the game. Components of the game engine include a physics engine 640 used to simulate physical interactions between virtual objects in the game state, a rules engine 645 for implementing the rules of the game, an RNG that may be used for influencing or determining certain variables and/or outcomes to provide a randomizing influence on game play, a graphics engine 650 used to generate a visual representation of the game state to the player, an audio engine to generate audio outputs for the player interface, and any other engine needed to provide the entertainment game. The game engine 612 reads and writes game resources 615 stored on a data store of the ESE host. The game resources 615 include game objects 655 having graphics and/or control logic used to implement game world objects of the game engine. The game resources 615 also include video files 675 that are used to generate cut-scenes for the entertainment game. The game resources 615 may also include audio files 660 used to generate music, sound effects, etc. within the entertainment game. The game resources 615 may also include configuration files 670 used to configure the features of the entertainment game. The game resources 615 may also include scripts 665 or other types of control code used to implement various game play features of the entertainment game. The game resources 615 may also include graphics resources 680 including, but not limited to, textures, and objects that are used by the game engine to render objects displayed in the entertainment game.

In operation, components of the game engine 612 read portions of the game state 625 and generate the player presentation for the player which is presented to the player using the player interface 605. The player perceives the presentation 635 and provides player inputs using the HIDs 630. The corresponding player inputs are received as player actions or inputs by various components of the game engine 612. The game engine translates the player actions into interactions with the virtual objects of the game world stored in the game state 625. Components of the game engine 612 use the player interactions with the virtual objects of the game and the game state 625 to update the game state 625 and update the presentation 635 presented to the user. The process loops in a game loop continuously while the player plays the game.

The ESE 610 provides one or more interfaces between an entertainment game and other components 620 of a gambling hybrid game, such as a GWE. The ESE 610 and the other gambling hybrid game component 620 communicate with each other using the interfaces, such as by passing various types of data and sending and receiving messages, status information, commands and the like. Examples of communications include, but are not limited to, requesting by the gambling hybrid game component 620 that the ESE 610 update the game state using information provided by the other component; requesting, by the gambling hybrid game component 620, that the ESE 610 update one or more game resources using information provided by the gambling hybrid game component 620; the ESE 610 providing all or a portion of the game state; the ESE 610 providing one or more of the game resources to the gambling hybrid game component 620; and the ESE 610 communicating player actions to the other gambling hybrid game component 620. The player actions may be low level player interactions with the player interface, such as manipulation of an HID, or may be high level interactions with objects as determined by the entertainment game. The player actions may also include resultant actions such as modifications to the game state or game resources resulting from the player's actions taken in the game. Other examples of player actions include actions taken by entities, such as Non-Player Characters (NPC) of the entertainment game, that act on behalf of, or under the control of, the player.

Elements are a limited resource consumed within an entertainment game to advance entertainment game gameplay. In playing the entertainment game using the elements, a player can (optionally) consume and accrue game world credits (GWC) within the entertainment game. These credits can be in the form of (but are not limited to) game world credits, experience points, or points generally. Wagers can be made in the gambling game as triggered by the player's use of one or more elements of the entertainment game. The wagers are made using real world credits (RC). The real world credits can be credits in an actual currency, or can be credits in a virtual currency which may have a real world value. Gambling outcomes from the gambling game can cause consumption, loss or accrual of RC. In addition, gambling outcomes in the gambling game can influence elements in the entertainment game such as (but not limited to) by restoring a consumed element, causing the loss of an element, restoration or placement of a fixed element. In certain embodiments, gambling games can facilitate the wager of GWC for a randomly generated payout of GWC or a wager of elements for a randomly generated payout of elements. In particular embodiments, an amount of GWC and/or elements used as part of a wager can have a RC value if cashed out of a gameplay session.

Example elements include enabling elements (EE) which are elements that enable a player's play of the entertainment game and whose consumption by the player while playing the entertainment game can trigger a wager in a gambling game. Another non limiting example of an element is a reserve enabling element (REE), which is an element that converts into one or more enabling elements upon occurrence of a release event in skill wagering interleaved game gameplay. Other types of elements include actionable elements (AE) which are elements that are acted upon to trigger a wager in the gambling game and may or may not be restorable during normal play of the entertainment game. Another type of element is a common enabling element (CEE) which as an element that may be shared by two or more players and the use of which by any of the players causes a wager to be triggered.

In progressing through entertainment game gameplay, elements can be utilized by a player during interactions with a controlled entity (CE) which is a character, entity, inanimate object, device or other object under control of a player.

Also, entertainment game gameplay progress and wager triggers can be dependent upon a game world variable such as, but not limited to: a required game object (RGO) which is a specific game object in an entertainment game acted upon for an AE to be completed (such as but not limited to a specific key needed to open a door); a required environmental condition (REC) which is a game state present within an entertainment game for an AE to be completed (such as but not limited to daylight whose presence enables a character to walk through woods); or a controlled entity characteristic (CEC) which is a status of the CE within an entertainment game for an AE to be completed (such as but not limited to a CE to have full health points before entering battle). Although various gameplay resources, such as but not limited to GWC, RC and elements as discussed above, any gameplay resource can be utilized to advance gameplay as well as form the basis for a trigger of a wager as appropriate to the specification of a specific application in accordance with various embodiments of the invention. Various hybrid games are discussed in PCT Application Nos. PCT/US11/26768, filed Mar. 1, 2011, PCT/US11/63587, filed Dec. 6, 2011, and PCT/US12/50204 filed Aug. 9, 2012, each disclosure of which is hereby incorporated by reference in its entirety.

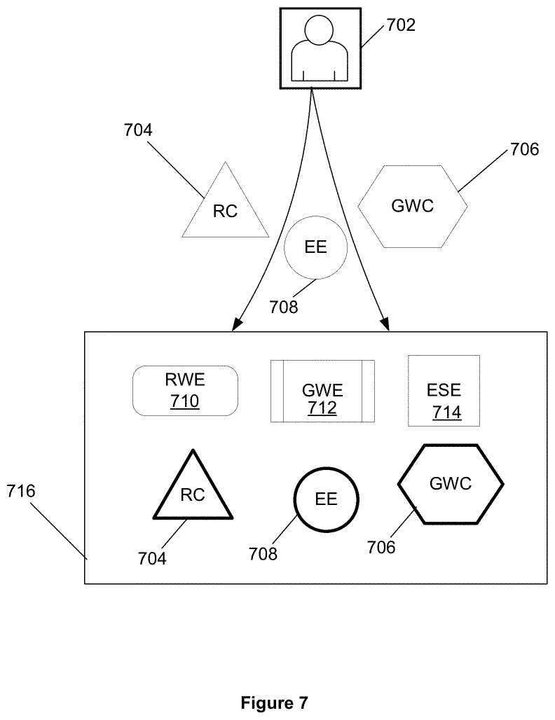

In accordance with some embodiments, a player can interact with a gambling hybrid game by using RC in interactions with a gambling game along with GWC and elements in interactions with an entertainment game. The gambling game can be executed by a RWE while an entertainment game can be executed with an ESE and managed with a GWE. A conceptual diagram that illustrates how resources such as GWC, RC and elements, such as but not limited to enabling elements (EE), are utilized in a gambling hybrid game in accordance with an embodiment of the invention is illustrated in FIG. 7. The conceptual diagram illustrates that RC 704, EE 708 and GWC 706 can be utilized by a player 702 in interactions with the RWE 710, GWE 712 and ESE 714 of a based gambling hybrid game 716. The contribution of elements, such as EE 708, can be linked to a player's access to credits, such as RC 704 or GWC 706. Electronic receipt of these credits can come via a smart card, voucher or other portable media, or as received over a network from a server. In accordance with certain embodiments, these credits can be drawn on demand from a player profile located in a database locally on a gambling hybrid game or in a remote server.

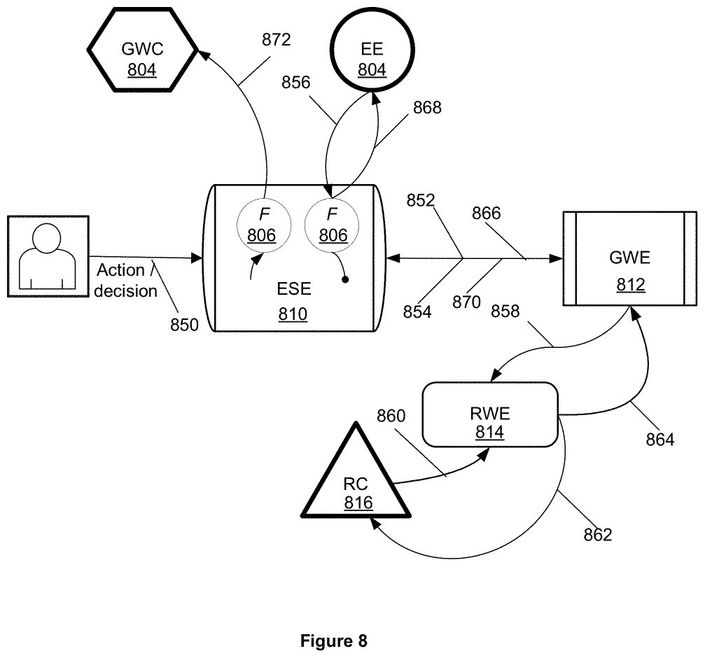

A conceptual diagram that illustrates the interplay between aspects of a gambling hybrid game in accordance with an embodiment of the invention using real world credit (RC) is illustrated in FIG. 8. Similar to FIG. 7, a player's actions and/or decisions can affect functions 806 that consume and/or accumulate GWC 802 and/or EE 804 in an entertainment game executed by an ESE 810. A GWE 812 can monitor the activities taking place within an entertainment game executed by an ESE 810 for gameplay gambling event occurrences. The GWE 812 can also communicate the gameplay gambling event occurrences to an RWE 814 that triggers a wager of RC 816 in a gambling game executed by the RWE 814.

In accordance with some embodiments of the invention, the following may occur during use of the gambling hybrid game. The user enters an input that represents an action or decision (850). The ESE 810 signals the GWE 812 with the input decision or action (852). The GWE 812 responds by signaling to ESE 810 with the amount of EE that is consumed by the player action or decision (854). The signaling from the GWE 812 configures a function 806 to control the EE consumption, decay, and/or accumulation.

The ESE 810 then adjusts the EE 804 accordingly (856). The GWE 812 signals the RWE 814 as to the profile of the wager proposition associated with the action or decision and triggers the wager (858). The RWE 814 consumes the appropriate amount of RC 816 and executes the wager (860). The RWE 814 then adjusts the RC 816 based upon the outcome of the wager (862) and informs the GWE 812 as to the outcome of the wager (864).

The GWE 812 signals the ESE 810 to adjust EE to one or more of the EEs of the ESE entertainment game (866). Function 806 of the ESE 810 performs the adjustment of EE 804 (868). The ESE 810 signals the GWE 812 as to the updated status (870). In response, the GWE 812 signals the ESE 810 to update GWC of the entertainment game. The ESE updates the GWC 802 using a function 806 (872).

The following is an example of the above flow in a first person shooter game, such a Call of Duty®, using a gambling hybrid game sequence in accordance with embodiments of the invention.

The process begins by a player selecting a machine gun to use in the game and then fires a burst of bullets at an opponent (850). The ESE 810 signals the GWE 812 of the player's choice of weapon, that a burst of bullets was fired, and the outcome of the burst (852). GWE 812 processes the information received and signals ESE 810 to consume 3 bullets (EE) with each pull of the trigger (854). The ESE 810 consumes 3 bullets for the burst using function 806 (856).

The GWE 812 signals the RWE 814 that 3 credits (RC) are to be wagered to match the three bullets consumed. The RWE 814 then determines the result of the wager and may determine the winnings from a pay table. On a particular pay table (Table Ln-RC), a determination is made by RWE 814 as to the amount of damage that the opponent has sustained. The RWE 814 consumes 3 credits of RC 816 for the wager and executes the specified wager (860). The RWE 814 determines that the player hit a jackpot of 6 credits and returns the 6 credits to the RC 816 (862) and signals the GWE 812 that 3 net credits were won by the player (864).

The GWE 812 signals ESE 810 to add 3 bullets to an ammunition clip (866). ESE 810 adds 3 bullets back to the ammo clip (EE 804) using a function 806 (868). The ammunition may be added by directly adding the ammunition to the clip or by allowing the user to find extra ammunition during game play. The GWE 812 logs the new player score (GWC 802) in the game (as a function of the successful hit on the opponent) based on the ESE 810 signaling, and the signals the ESE 810 to add 2 extra points to the player score since a jackpot has been won (870). The ESE 810 then adds 10 points to the player score (GWC 802) given the success of the hit which in this example is worth 8 points, plus the 2 extra points requested by GWE 812 (872). Note that the foregoing example is only intended to provide an illustration of how credits flow in a gambling hybrid game, but is not intended to be exhaustive and only lists only one of numerous possibilities of how a gambling hybrid game may be configured to manage its fundamental credits.

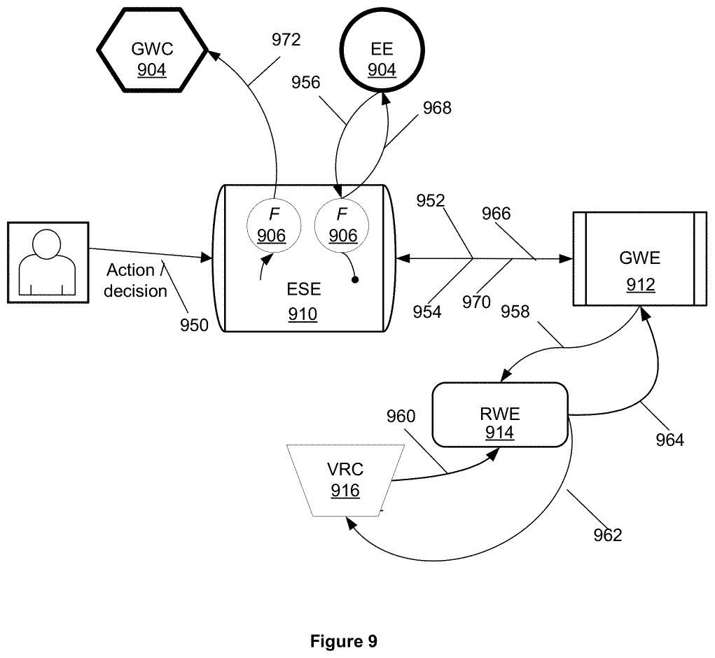

A conceptual diagram that illustrates the interplay between aspects of a gambling hybrid game in accordance with an embodiment of the invention using Virtual real world credit (VRC) is illustrated in FIG. 9. As seen in the FIG. 9, substituting VRC in place of RC is effected without impact to the architecture or operation of the gambling hybrid game. The implementation of FIG. 9 is not the only embodiment using virtual currency within a gambling hybrid game, but shows only one permutation of which many could exist.

Similar to FIG. 8, a player's actions and/or decisions can affect functions 906 that consume and/or accumulate GWC 902 and/or EE 904 in an entertainment game executed by an ESE 910 in the process shown in FIG. 9. A GWE 912 can monitor the activities taking place within an entertainment game executed by an ESE 910 for gameplay gambling event occurrences. The GWE 912 can also communicate the gameplay gambling event occurrences to a RWE 914. Unlike the process shown in FIG. 8, RWE 914 triggers a wager of Virtual real world credit (VRC) 916 in a gambling game executed by the RWE 914.

For purposes of this discussion, VRC can be thought of as a form of alternate currency, which can be acquired, purchased or transferred, in unit or in bulk, by/to a player, but does not necessarily directly correlate to RC or real currency. As an example, there is a virtual currency called “Triax Jacks”, 1000 units of which are given to a player by an operator of a gambling hybrid game, with additional blocks of 1000 units being available for purchase for $5 USD each block. Triax Jacks could be redeemed for various prizes, or could never be redeemed but simply used and traded purely for entertainment value by players. It would be completely consistent with the architecture of the gambling hybrid game that Triax Jacks would be wagered in place of RC, such that the gambling hybrid game could be played for free, or with played with operator sponsored Triax Jacks.

Returning to the process in FIG. 9, the following may occur during use of the gambling hybrid game in accordance with embodiments of the invention. The user enters an input that represents an action or decision (950). The ESE 910 signals the GWE 912 with the input decision or action (952). The GWE 912 responds by signaling to ESE 910 with the amount of EE that is consumed by the player action or decision (954). The signaling from the GWE 912 configures a function 906 to control the EE consumption, decay, and/or accumulation.

The ESE 910 then adjusts the EE 904 accordingly (956). The GWE 912 signals the RWE 914 as to the profile of the wager proposition associated with the action or decision and triggers the wager (958). The RWE 914 consumes the appropriate amount of RC 916 and executes the wager (960). The RWE 914 then adjusts the RC 916 based upon the outcome of the wager (962) and informs the GWE 912 as to the outcome of the wager (964).

The GWE 912 signals the ESE 910 to adjust EE to one or more of the EEs of the ESE entertainment game (966). Function 906 of the ESE 910 performs the adjustment of EE 904 (968). The ESE 910 signals the GWE 912 as to the updated status (970). In response, the GWE 912 signals the ESE 910 to update GWC 902 of the entertainment game. The ESE updates the GWC 902 using a function 906 (972).

### Network Based Gambling Hybrid Game

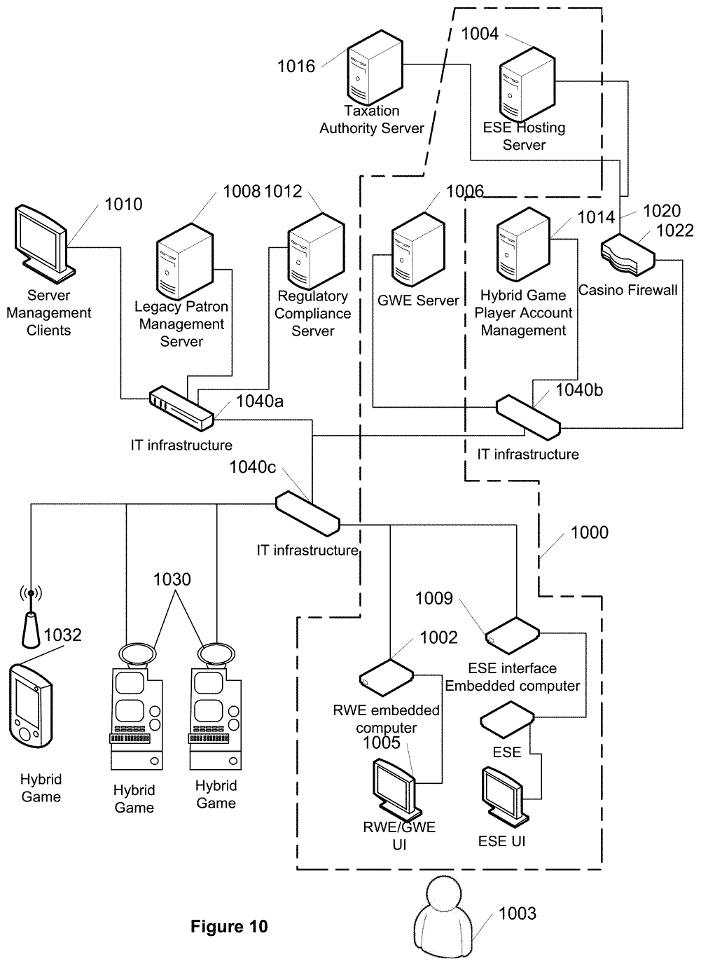

A system diagram that illustrates an implementation of a network distributed gambling hybrid game with a GWE local server in accordance with embodiments of the invention is illustrated in FIG. 10. In the figure, the gambling hybrid game 1000 includes components, RWE 1002 embedded in a device used as the user interface for player 1003. The device provides both a RWE/GWE user interface 1005 and an ESE user interface 1007 for the player. The ESE is provisioned by an ESE hosting server 1004 via ESE interface 1009, and the GWE is provisioned by GWE server 1006 as indicated by the dashed line. Also pictured in the diagram are a number of other peripheral systems, such as player management 1008, casino management 1010, regulatory 1012, hybrid game player account management 1014, and taxation authority 1016 hosting servers that may be present in such an implementation. FIG. 10 also illustrates various other systems, which may reside outside the bounds of the casino and are connected to the framework via communications network, such as the Internet 1020, depicted by the connection lines past the casino firewall 1022. The end devices utilized for user interfaces for a gambling hybrid game include, but are not limited to, casino electronic game machines 1030 and wireless or portable devices, such as smart phone 1032, personal digital assistants, tablet computers, video gaming consoles or the like. These disparate devices are connected within and without the casino through the casino's information technology structure as illustrated by routers 1040a, 1040b and 1040c. It should be understood that FIG. 10 does not attempt to illustrate all servers and systems to which a gambling hybrid game 1000 might be inevitably be connected, and indeed one might expect there would be others, but rather provides an example of a set of a sub-set of systems which would be present in an exemplary embodiment of an installation.

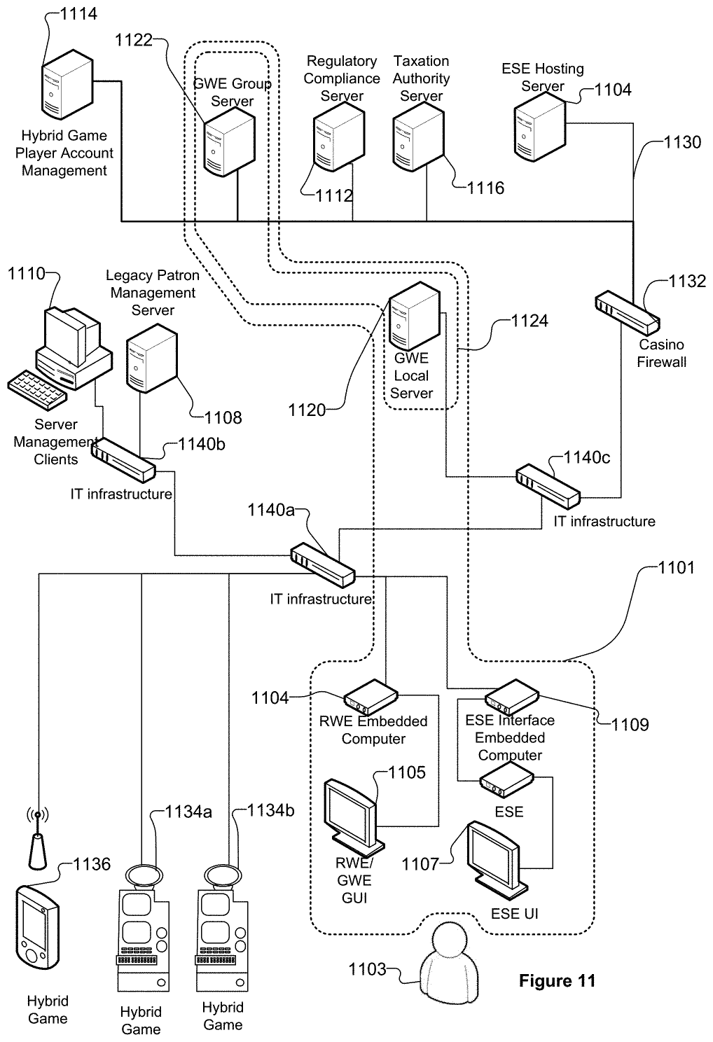

FIG. 11 is a diagram showing another implementation of a gambling hybrid game in accordance with an exemplary embodiment. In the figure, the gambling hybrid game 1101 includes components, RWE 1104 embedded in a device used as the user interface for player 1103. The device provides both a RWE/GWE user interface 1105 and an ESE user interface 1007 for the player. The ESE is provisioned by an ESE hosting server 1104 via ESE interface 1109. Also pictured in the diagram are a number of other peripheral systems, such as player management 1108, casino management 1110, regulatory 1112, hybrid game player account management 1114, and taxation authority 1116 hosting servers that may be present in such an implementation. In the figure, note that the GWE is composed of two sub-components, a local GWE server 1120, and a cloud server 1122. (components within the dash line area 1124). In the figure, certain of the components are located within the bounds of the casino, namely the RWE, the ESE and a portion of the GWE, namely the local GWE server 1120. The Cloud Server GWE 1122 is located in the cloud connected to the casino bounded gambling hybrid game components via communications network such as the Internet 1130 through a firewall 1132. FIG. 11 also illustrates various other systems, which may reside outside the bounds of the casino and are connected to the framework via communications network. The end devices utilized for user interfaces for a gambling hybrid game include, but are not limited to, casino electronic game machines, 1134a and 1134b, and wireless or portable devices, such as smart phone 1136, personal digital assistants, tablet computers, video gaming consoles or the like. These disparate devices are connected within and without the casino through the casino's information technology structure as illustrated by routers 1140a, 1140b and 1140c. It should be understood that FIG. 11 does not attempt to illustrate all servers and systems to which a gambling gambling hybrid game might be inevitably be connected, and indeed one might expect there would be others, but rather provides an example of a set of a sub-set of systems which would be present in an exemplary embodiment of an installation.

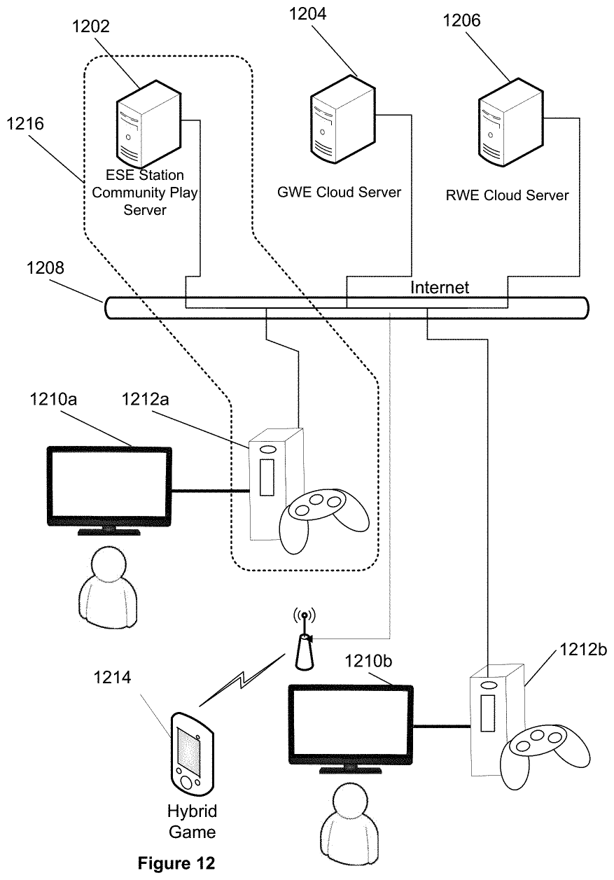

A system diagram that illustrates an implementation of network a cloud based gambling hybrid game over the Internet in accordance with an embodiment of the invention is illustrated in FIG. 12. The system includes an ESE server 1202, GWE server 1204 and RWE server 1206 that each connect to a user interface, 1210a or 1210b, (such as, but not limited to, a television screen, computer terminal, tablet, touchscreen or PDA) of gambling hybrid games over the Internet 1208. Each gambling hybrid game includes a local ESE 1212a or 1212b (such as, but not limited to, a video game console or a gaming computer system) that interfaces with a remote ESE server 1002. Processes performed by an ESE 1212a services can be performed in multiple locations, such as, but not limited to, remotely on an ESE server 1202 and locally on a local ESE 1212a. In addition, a gambling hybrid game may include a Personal Digital Assistant (PDA) 1214 or other type of mobile computing device game coupled to the ESE hosting server 1202, thus providing the opportunity for a player to play a gambling hybrid game on the PDA through a mobile phone or data network.

There are many possible permutations of how a gambling hybrid game could be constructed, with FIGS. 10, 11 and 12 showing only three possible permutations and provided as examples, which are not intended to suggest limitations to the forms of the architecture. Other embodiments include a version where the entire gambling hybrid game is in the cloud with only a client running on player terminal within the bounds of the casino, or a version where the RWE and GWE are casino bound and the ESE exists in the cloud, accessed by a client running on a terminal in the casino.

### Processing Apparatuses

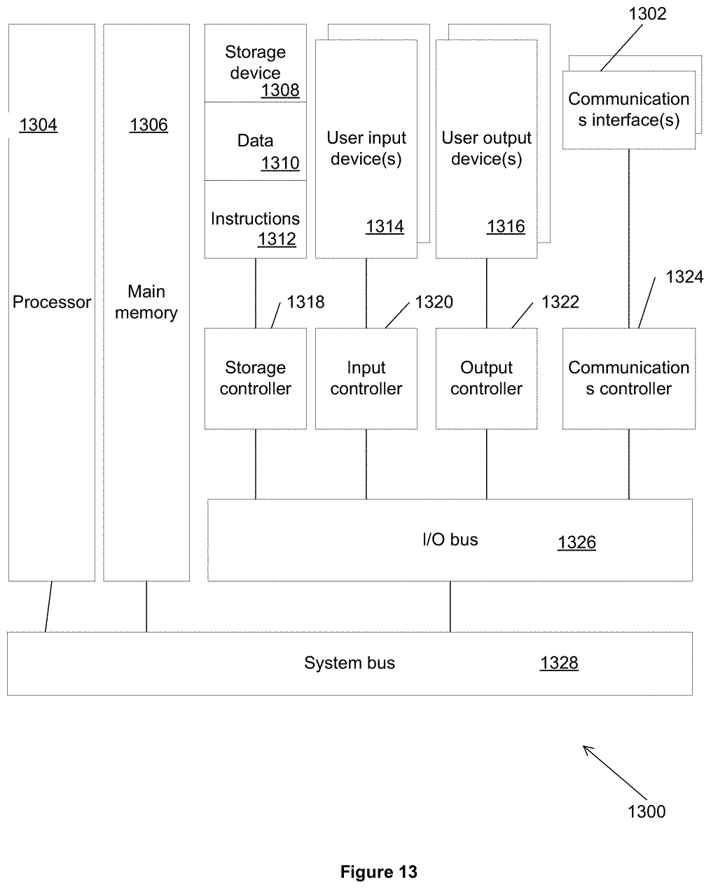

Any of a variety of processing apparatuses can host various components of a gambling hybrid game in accordance with embodiments of the invention. In accordance with embodiments of the invention, these processing apparatuses can include, but are not limited to, mobile device such as a smartphone, personal digital assistant or the like, a wireless device such as a tablet computer or the like, an electronic gaming machine, a general purpose computer, a computing device and/or a controller. A processing apparatus that is constructed to implement a gambling hybrid game in accordance with embodiments of the invention is illustrated in FIG. 13. In the processing apparatus 1300, a processor 1304 is coupled to a memory 1306 by a bus 1328. The processor 1304 is also coupled to non-transitory processor-readable storage media, such as a storage device 1308 that stores processor-executable instructions 1312 and data 1310 through the system bus 1328 to an I/O bus 1326 through a storage controller 1318. The processor 1304 is also coupled to one or more interfaces that can be used to connect the processor to other processing apparatuses as well as networks as described herein. The processor 1304 is also coupled via the bus to user input devices 1314, such as tactile devices including, but not limited to, keyboards, keypads, foot pads, touch screens, and/or trackballs; as well as non-contact devices such as audio input devices, motion sensors and motion capture devices that the processing apparatus can use to receive inputs from a user when the user interacts with the processing apparatus. The processor 1304 is connected to these user input devices 1314 through the system bus 1328, to the I/O bus 1326 and through the input controller 1320. The processor 1304 is also coupled via the bus to user output devices 1316 such as (but not limited to) visual output devices, audio output devices, and/or tactile output devices that the processing apparatus uses to generate outputs perceivable by the user when the user interacts with the processing apparatus. In accordance with some embodiments, the processor is coupled to visual output devices such as (but not limited to) display screens, light panels, and/or lighted displays. In accordance with particular embodiments, the processor is coupled to audio output devices such as (but not limited to) speakers, and/or sound amplifiers. In accordance with many of these embodiments, the processor 1304 is coupled to tactile output devices like vibrators, and/or manipulators. The processor 1304 is connected to output devices from the system bus 1328 to the I/O bus 1326 and through the output controller 1322. The processor 1304 can also be connected to a communications interface 1302 from the system bus 1328 to the I/O bus 1326 through a communications controller 1324.

In accordance with various embodiments, a processor 1304 can load instructions and data from the storage device into the memory 1306. The processor 1304 can also execute instructions that operate on the data to implement various aspects and features of the components of a gambling hybrid game. The processor 1304 can utilize various input and output devices in accordance with the instructions and the data in order to create and operate user interfaces for players or operators of a gambling hybrid game(such as but not limited to a casino that hosts the gambling hybrid game).

Although the processing apparatus 1300 is described herein as being constructed from a processor and instructions stored and executed by hardware components, the processing apparatus can be composed of only hardware components in accordance with other embodiments. In addition, although the storage device is described as being coupled to the processor through a bus, those skilled in the art of processing apparatuses will understand that the storage device can include removable media such as, but not limited to, a USB memory device, an optical CD ROM, magnetic media such as tape and disks. Also, the storage device can be accessed by processor 1304 through one of the interfaces or over a network. Furthermore, any of the user input devices or user output devices can be coupled to the processor 1304 via one of the interfaces or over a network. In addition, although a single processor 1304 is described, those skilled in the art will understand that the processor 1304 can be a controller or other computing device or a separate computer as well as be composed of multiple processors or computing devices including one or more processors.

### Provision of a Standardized Scoring System for Gambling Hybrid Games

In gambling hybrid games, game world credit (GWC) scoring (the addition or subtraction of GWC to a player's account) can be either independently determined by an individual gambling hybrid game, or a standardized system of scoring applied to more than one gambling hybrid game. A standardized GWC scoring system can be of value because a standardized system enables a unified mechanism for managing tournament entry, evaluating player performance across multiple game titles, and simplifying and/or eliminating the need for an exchange dedicated to trading GWC (the GWCE). A standardized scoring system is designed around the previously described idea of a universal GWC, or UGWC. A standardized scoring system (SSS) is established for a class of games, where the class can be narrowly or broadly defined. Examples of classes include, but are not limited to: 1st person shooter games with campaigns; closed-end (i.e. finite duration) word and puzzle games; sports games; a set of gambling hybrid games using the same ESE; a set of gambling hybrid games developed by the same entertainment game studio; a set of gambling hybrid games within a given casino group's properties; and a set of gambling hybrid games across multiple casinos.

There are a number of different types of games that can be considered when considering the use and application of a SSS. One type of game is a turn-based game. Turn based games are finite in length, i.e. a range of scores can be considered with well-established bounds. For example, in a game like Scrabble™, the range of possible game scores can be established with a relatively high degree of certainty. A second type of game is an indeterminate game. Indeterminate games, such as World of Warcraft, may be played for an indeterminate amount of time and have a variety of possible scoring mechanisms. Thus, the ultimate scoring potential for a given player in a session of game play is indeterminate. In these indeterminate games, the SSS needs a construct for standardized UGWC scoring may therefore be parameterized along one or more dimensions that are standardized for all games covered by that SSS. Examples of parameterizing factors include, but are not limited to, the following factors: elapsed real time, elapsed game time, RC committed, and RC lost. When a parameterizing variable or variables are used, the calculation of UGWC will generally take as an argument that parameterizing variable.

In accordance with embodiments where the amount of RC committed is a parameterizing factor, the scoring range for an indeterminate game can be represented as {M,N::RC Committed} where the range of UGWC accumulated is between M and N, when a maximum of “RC Committed” is put into play by the player. In accordance with some more general of these embodiments, the scoring range can be represented as {M,N::RC Committed LOW, RC Committed HIGH} where the range of RC Committed is between the LOW and HIGH values, the range of resulting SSS GWC (i.e. UGWC) scores is between M and N. The operator implementing the Standardized Scoring System dictates the range {M, N} in the context of {RC Committed LOW, RC Committed HIGH} so that GWC accumulated in one of any of the gambling hybrid games covered by the SSS can be considered equivalent to the GWC accumulated in any other of the gambling hybrid games covered by the SSS, i.e. so that in effect, all the games within a SSS are utilizing a UGWC. Therefore, there is no need for an exchange of GWC of different types at a predetermined or calculated exchange rate (for example) via a GWCE to use the GWC in different gambling hybrid games.

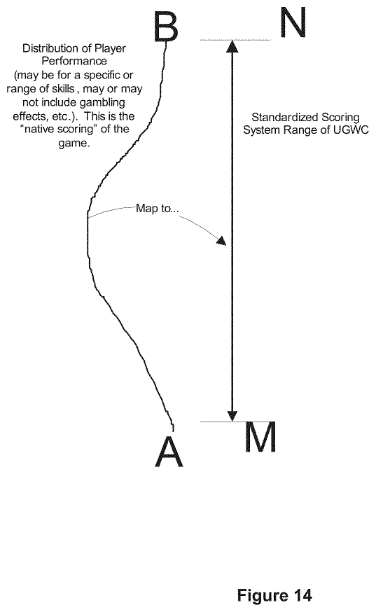

A mapping of a distribution of scores in a gambling hybrid game's native scoring system (range A→B) to the SSS scoring range {M,N} is shown in FIG. 14. The distribution shows the distribution of scores from different players between A and B in the gambling hybrid game, and that each of the scores are then mapped across to the range {M, N} in the SSS either in direct proportion to the distribution of player scores, or via another mechanism that can take into account a range of variables. The distribution may be produced from a small sample group, as a historical record of all prior game play sessions, as a historical record of game scores during a specific time period, some other sampling group or using any other metric of past scores. The distribution curve is game specific, but the range {M,N} and the logic/formulae used to translate the game specific scoring and distribution of results to that SSS range is standardized within a SSS domain.

One skilled in the art will note that there need not be a single mapping function between a gambling hybrid game's scoring system (the local GWC of the game in effect) and a universal GWC (i.e. UGWC) in use in the SSS. A series of mapping functions can be used as a function of skill ratings for players (i.e. a different mapping function may exist for low, medium, high skill players' score distributions), or there may be parameterization of the mapping function(s) as a function of variables such as RC committed, RC lost, RC won, amount of time the game is played, and the like.

In accordance with some embodiments where a parameterizing variable or variables are deployed, the final amount of UGWC accumulated by the player in the SSS context associated with a specific gambling hybrid game session in real-time may not be ascertained until the gambling hybrid game session is completed. In accordance with some other embodiments where a parameterizing variable or variables are deployed, the mapping to the SSS range {M,N} may be done in a discrete fashion during game play as a function of the parameterizing variable(s). For example, if the parameterizing variable is game time played and the mapping function (or native system in the case where the native system is designed in the gambling hybrid game as a function of the SSS) is built around a small unit of elapsed time (e.g. 10 seconds) relative to overall game time expected in a session (e.g. 5 minutes), the UGWC associated with gambling hybrid game play within the SSS context can be regularly updated and presented to the user. However, in many, if not all, cases, the discrete nature of UGWC accumulation or declination may not be appealing to the player and may not be presented to the player during a gambling hybrid game session.

In accordance with some embodiments of the invention, the mapping of scores from a specific gambling hybrid game to a UGWC in SSS context may involve an inversion. Inversion may be needed in gambling hybrid games (e.g. Blokus) where a lower score is better. When the scores of these games are converted to a UGWC in the context of a SSS (or when a scoring system is directly implemented in an implementation of Blokus to reflect SSS requirements) the mapping must be inverted such that player's achieve a higher UGWC for having fewer remaining squares un-played while a player with more remaining squares unplayed achieve a lower UGWC. An inversion allows Blokus and similar games to align with scoring systems of other games that would be subsumed under the same SSS. Likewise, in part because of this inversion, it may not be possible to display a player's UGWC score in Blokus until the game is completed.

In accordance with an embodiment of a gambling hybrid game that includes Blokus, the following is an example of the scoring in the gambling in the game and the conversion to UGWC. A player starts Blokus with 89 squares and seeks to end up with as few squares (ideally zero) as possible. In a SSS with range {0,200}, having 89 squares left at the end of the game would correspond to a UGWC of zero, and having zero squares left at the end of the game would correspond to a UGWC of 200. One skilled in the art will recognize that values could be linearly transposed between these end points and the above is given as an example only.

In accordance with several embodiments of the invention, the SSS uses a fixed range of UGWC scores for all games within a class. The fixed range of UGWC scores is denoted as {M, N}. Each gambling hybrid game is slotted into a SSS such that the native scoring system of the gambling hybrid game is mapped to the {M, N} range by one of a number of processes.

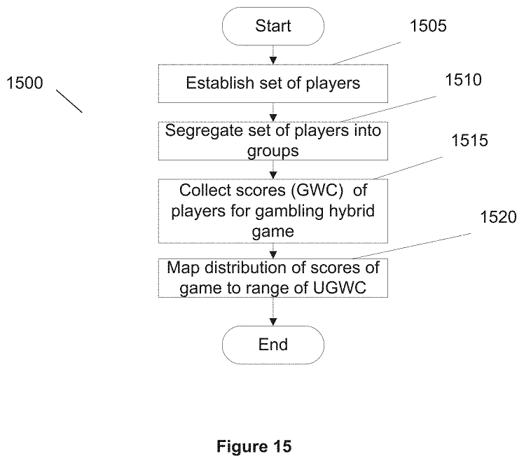

A process for slotting the GWC scores of a gambling hybrid game into a range of {M, N} of UGWC in accordance with some embodiments of the invention is shown in FIG. 15. SSS Slotting Process 1500 is performed to determine the mapping of GWC to UGWC for a particular hybrid gambling game. Process 1500 includes establishing a set of players to test (1505). The set of players includes a test or control group that is used to determine the correlation between the GWC earned during play of the gambling hybrid game to the UGWC. The set of players may then be segregated into groups of players based upon skill level in playing the gambling hybrid game or other factors (1510).

Each of the players then plays the gambling hybrid game. The gambling hybrid game is played until a certain metric is met. The metrics may include, but are not limited to, a period of time, a level of the game, a life of a player, or a particular resource is expended. Process 1500 collects the scores or GWC of each of the players and uses the scores to establish a distribution of native scores for a population of players (1515). One skilled in the art will note that the play of the gambling hybrid game may be conducted in a skill-only mode or a skill+gambling mode.

The resulting distribution of native skills is mapped to the {M, N} range of UGWC (1520). Examples of process that may be used to map the distribution to the range include, but are not limited to:
(i) a weighting application of the native scores to the {M, N} range based on the distribution of players against the native scores, (i.e. if the 30th percentile native score is 27,654 and the range in the SSS is {0, 10000} the native score 27,654 correlates to a UGWC value of 3,000);
(ii) a linear mapping of the native scores to the {M, N} range irrespective of the distribution of players relating to the underlying scores (i.e. if the native score range is {0, 20000} and the SSS range is {0, 10000}, each native score is divided by 2 to achieve the GWC in the SSS context;
(b) a non-linear mapping of the native scores to the {M, N} range irrespective of the distribution of players relating to the underlying scores; and
(c) a formulaic conversion that takes into account (in addition to the game session score(s)) one or more metrics, including but not limited to, the amount of time played and/or the amount of RC wagered, RC won, RC lost, underlying player skill, and/or game difficulty settings.

After process 1500, the determined map is provided to the GWE of the gambling hybrid game for use in converting the GWC of the gambling hybrid game to UGWC and the UGWC are added to a player account of the player for future use. One skilled in the art will recognize that process 1500 may be performed continuously, prior to releasing the gambling hybrid game into the casino environment, and/or periodically depending on how the operator chooses to implement the standardized scoring system.

In accordance with some embodiments of the invention, each gambling hybrid game scoring system is constructed to have a scoring range of {M, N} as dictated by the SSS to which the game is to be related. A mapping is not required because the gambling hybrid game includes a scoring system that conforms to the SSS requirements. In this approach, factors such as player skill may or may not be considered, and the manner in which events in the game are scored may be based on the game playing skills of the player and/or the results of gambling events during game play depending upon the guidelines established for the SSS and/or the operator.

There are a number of different types of games that may be considered when considering the use of an SSS, and applying it. For example, some turn-based games, are finite in length, i.e. a range of scores can be considered with well-established bounds. In a game like Scrabble, for example, the range of possible game scores can be established with a relatively high degree of certainty, whereas in some games, such as World of Warcraft, the time of play can be indeterminate, with a variety of possible scoring mechanisms, leaving the ultimate scoring potential for a given player indeterminate.

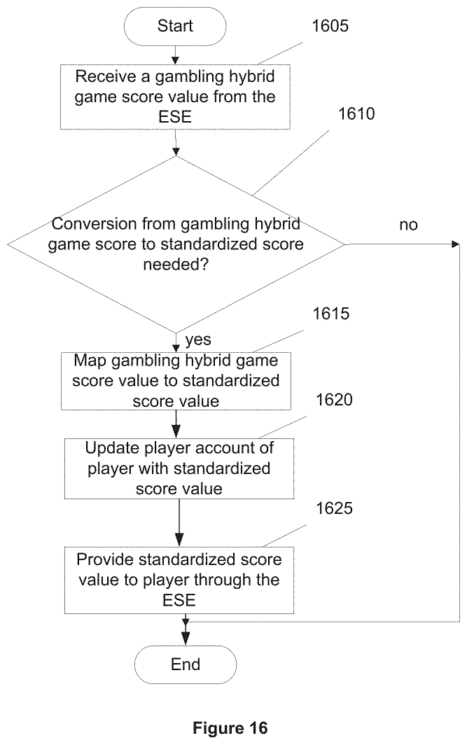

A process performed by a game world engine (GWE) to determine a standardized score value (UGWC) from a gambling hybrid game score value (GWC) in accordance with embodiments of the invention is shown in FIG. 16. The process may be performed by a GWE operating in the gambling hybrid game or a component of the GWE that is being provided over a network (i.e. the GWCE of the GWE). Process 1600 includes receiving a gambling hybrid game score value in the GWE from the ESE (1605). The gambling hybrid game score value may be the total score or GWC that the player accumulated during a game play session of the gambling hybrid game or a may be a periodical update of the amount of GWC that the play has accumulated during a particular time period measured by a metric such as, but not limited to, a time period or a particular unit of game play.

Process 1600 determines whether a conversion to a standardized score value or UGWC value is needed based upon the receipt of the GWC value (1610). The determination may be performed when the GWE only adds UGWC to a player account of the player based on a particular event in game play and/or some other game play metric of the gambling hybrid game. If a conversion is needed, the GWE maps the gambling hybrid game score (GWC) value to a standardized score value (1615). The mapping may be performed in any number of ways including but not limited to, a weighting application, a linear mapping, a non-linear mapping, and a formulaic conversion. The determined standardized score value is then used to update the player account of the player of the gambling hybrid game (1620) and may be provided to the player though the user interface of the ESE.

Although certain specific features and aspects of a gaming system have been described herein, many additional modifications and variations would be apparent to those skilled in the art. For example, the features and aspects described herein may be implemented independently, cooperatively or alternatively without deviating from the spirit of the disclosure. It is therefore to be understood that gaming system may be practiced otherwise than as specifically described. Thus, the foregoing description of the gaming system should be considered in all respects as illustrative and not restrictive, the scope of the claims to be determined as supported by this disclosure and the claims' equivalents, rather than the foregoing description.

What is claimed is:

1. An electronic gaming machine for standardized scoring wagering, comprising:
an entertainment software engine hosted by the electronic gaming machine, wherein the entertainment software engine is connected to a game world engine, and wherein the entertainment software engine is constructed to:
execute an entertainment game having score values for gameplay;
determine a native score value for the player during the player's play of the entertainment game;
provide to the game world engine the native score value;
receive, from the game world engine a standardized score value; and
display the standardized score value to the player;
a real world engine hosted by the electronic gaming machine and connected to the game world engine, wherein the real world engine is constructed to:
determine a result of a wagering event using a random number generator; and
provide the results of the wagering event to the game world engine; and
the game world engine hosted by the electronic gaming machine and connected to the entertainment software engine and connected to the game world engine, wherein the game world engine is constructed to:
determine when a wagering event occurs during the player's play of the entertainment game;
request, from the real world engine, a resolution to the wagering event;
receive, from the entertainment software engine the native score value;
determine an amount of real credit commitment for the wagering event;
map the native score value to the standardized score value using a one to one correlation and the real credit commitment;
distribute the standardized score value to the player through the entertainment software engine; and
update an account of the player with the standardized score value.

2. The electronic gaming machine for standardized scoring wagering of claim 1, wherein the game world engine is further constructed to adjust the mapping of the native score value to the standardized score by also applying a linear mapping of the native score value to the standardized score in a particular range.

3. The electronic gaming machine for standardized scoring wagering of claim 1, wherein the game world engine is further constructed to adjust the mapping of the native score value to the standardized score by also applying a nonlinear mapping of the native score value to the standardized score in a particular range.

4. The electronic gaming machine for standardized scoring wagering of claim 1, wherein the game world engine is further constructed to map the score value to the standardized score by further applying a weighting application to the native score value to determine the standardized score within a range of standardized scores wherein the weighting application is based upon a distribution of players against score values.

5. The electronic gaming machine for standardized scoring wagering of claim 1, wherein the game world engine is further constructed to map the native score value to the standardized score by further applying a formulaic conversion to the native score value to determine the standardized score wherein the formulaic conversion takes into account at least one entertainment game metric.

6. An electronic gaming machine for standardized scoring wagering, comprising:
at least one processor; and
a memory connected to the at least one processor, the memory containing executable instructions that when executed by the processor cause the at least one processor to:
execute an entertainment game having score values for gameplay;
determine a native score value for the player during the player's play of the entertainment game;
determine when a wagering event occurs during the player's play of the entertainment game;
determine a result of the wagering event using a random number generator;
determine an amount of real credit commitment for the wager event;
map the native score value for the player to a standardized score value using a one to one correlation and the real credit commitment;
display the standardized score value to the player; and
update an account of the player with the standardized score value.

7. The electronic gaming machine for standardized scoring wagering of claim 6, wherein the executable instructions when executed by the at least one processor further cause the at least one processor to adjust the mapping of the native score value to the standardized score by also applying a linear mapping of the native score value to the standardized score in a particular range.

8. The electronic gaming machine for standardized scoring wagering of claim 6, wherein the executable instructions when executed by the at least one processor further cause the at least one processor to adjust the mapping of the native score value to the standardized score by also applying a nonlinear mapping of the native score value to the standardized score in a particular range.

9. The electronic gaming machine for standardized scoring wagering of claim 6, wherein the executable instructions when executed by the at least one processor further cause the at least one processor to map the native score value to the standardized score by further applying a weighting application to the native score value to determine the standardized score within a range of standardized scores wherein the weighting application is based upon a distribution of players against score values.

10. The electronic gaming machine for standardized scoring wagering of claim 6, wherein the game world engine is further constructed to map the native score value to the standardized score by further applying a formulaic conversion to the native score value to determine the standardized score wherein the formulaic conversion takes into account at least one entertainment game metric.
